(19) United States
(12) Patent Application Publication
(10) Pub. No.: US 2009/0226744 A1
(43) Pub. Date: Sep. 10, 2009

(54) COMPOSITIONS USEFUL TO MAKE NANOCOMPOSITE POLYMERS

(76) Inventor: Dmitry P. Dinega, Midland, MI (US)

Correspondence Address: The Dow Chemical Company, Intellectual Property Section, P.O. Box 1967, Midland, MI, 48641-1967, US

(21) Appl. No.: 12/299,565

(22) PCT Filed: May 15, 2007
(86) PCT No.: PCT/US2007/011604

§ 371 Date: Feb. 18, 2009

Related U.S. Application Data
(60) Provisional application No. 60/800,450, filed on May 15, 2006.

(51) Int. Cl. B32B 9/04; B01J 47/00

(52) U.S. Cl. 428/454; 521/25

(57) ABSTRACT

The present invention is a composition of comprising: a cation exchanging layered material having a cation exchanging capacity less than or fully exchanged with an organic cation, the cation exchanging layered material being in a liquid comprising an organic solvent, further characterized by one or more of the following (a) the cation exchanging layered material being delaminated into layers up to ten layers thick and more than ten layers thick where most of the material is present in ten layer thick units or less, (b) less than ten percent of the cation exchanging layered material settling upon exposure to 1,500 times gravity for one half hour; and (c) the average d-spacing of the layers of cation exchanging layered material being greater than three nanometers upon examination by x-ray diffraction spectroscopy. The instant invention is also a method for preparing a cation exchanging layered material for incorporation in a nanocomposite polymer, by the steps of: (a) dispersing a cation exchanging layered material in a liquid comprising water to form a dispersion; (b) adding an organic cation to the dispersion, the amount of organic cation being less than or equal to the cation exchanging capacity of the cation exchanging layered material; and (c) exchanging at least a portion of the water of the liquid for an organic solvent without drying the cation exchanged layered material. The invention also includes nanocomposite materials so made or incorporating such cation exchanging layered materials.

### FIELD OF THE INVENTION

The present invention is in the field of compositions of cation exchanging layered materials useful to make nanocomposite polymers and methods of preparing such compositions.

### BACKGROUND OF THE INVENTION

Delaminated or exfoliated cation exchanging layered materials (such as delaminated 2:1 layered silicate clays) can be used as reinforcing filler in a polymer system. Such polymer systems are known as “nanocomposites” when at least one dimension of the delaminated cation exchanging layered material is less than one hundred nanometers. Nanocomposite polymers generally have enhanced mechanical property characteristics over conventionally filled polymers. For example, nanocomposite polymers can provide both increased modulus, lower density, improved clarity, and/or lower coefficient of thermal expansion and in some instances increased impact toughness, a combination of mechanical properties that is not usually obtained using conventional fillers.

Cation exchanging layered materials are often treated with an organic cation (usually an “onium”) to facilitate delamination of the cation exchanging layered material when it is blended with a polymer (see, for example U.S. Pat. No. 5,973,053). However, the degree of delamination of the organic cation treated cation exchanging layered material in the polymer using prior art technology is not as high as desired. It would be an advance in the nanocomposite polymer art if the degree of delamination of the organic cation treated cation exchanging layered material in the polymer could be increased.

### SUMMARY OF THE INVENTION

The present invention provides a composition useful in making a nanocomposite polymer having excellent mechanical properties. In one embodiment, the invention is a composition comprising: a cation exchanging layered material having a cation exchanging capacity less than fully exchanged (i.e. partially exchanged) or fully exchanged with an organic cation, the cation exchanging layered material being in a liquid comprising an organic solvent, the cation exchanging layered material being delaminated into one, two, three, four, five, six, seven, eight, nine, and/or ten layers, and more than ten layers of cation exchanging layered material, the volume percent of the one, two, three, four, five, six, seven, eight, nine and ten layers of cation exchanging layered material being greater than the volume percent of the more than ten layers of cation exchanging layered material upon examination by transmission electron microscopy of a representative freeze dried sample of the composition.

In another embodiment, the invention is a composition of matter comprising: a cation exchanging layered material having a cation exchanging capacity less than or fully exchanged with an organic cation, the cation exchanging layered material being in a liquid comprising an organic solvent, less than ten percent of the composition settling upon exposure to 1,500 times gravity for one half hour.

In another embodiment, the invention is a composition of matter comprising: a cation exchanging layered material having a cation exchanging capacity less than or fully exchanged with an organic cation, the cation exchanging layered material being in a liquid comprising an organic solvent, the average layer to layer spacing of the layers of cation exchanging layered material being greater than three nanometers upon examination by x-ray diffraction spectroscopy.

In yet another embodiment, the instant invention is a method for preparing a cation exchanging layered material comprising the steps of: (a) dispersing a cation exchanging layered material in a liquid comprising water to form a dispersion; (b) adding an organic cation to the dispersion, the amount of organic cation being less than or equal to the cation exchanging capacity of the cation exchanging layered material; and (c) exchanging at least a portion of the water of the liquid for an organic solvent.

In another embodiment, the invention is a nanocomposite composition comprising the cation exchanging layered material of any one of the previous embodiments.

### BRIEF DESCRIPTION OF THE DRAWINGS

FIG. 1 is a transmission electron micrograph of an epoxy nanocomposite made using a composition of the instant invention; and

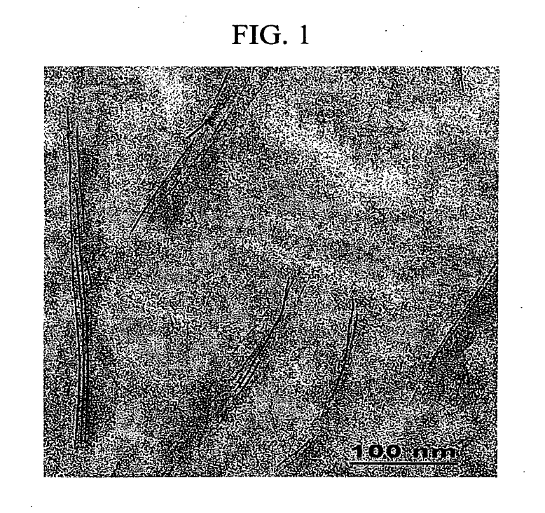

FIG. 2 is a transmission electron micrograph of a polypropylene nanocomposite made using a composition of the instant invention.

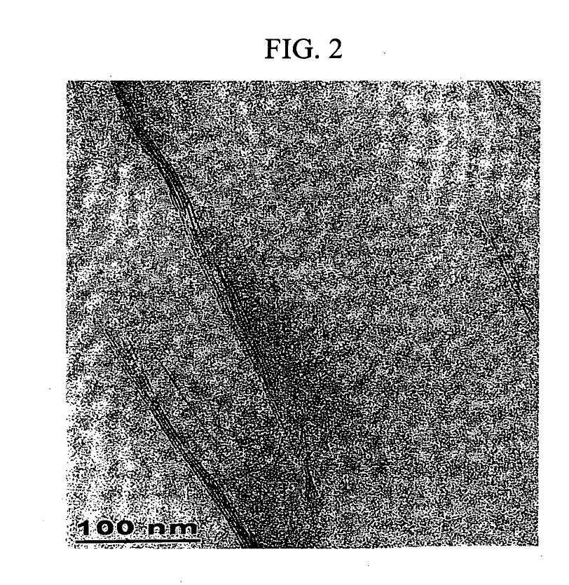

### DETAILED DESCRIPTION

Delaminated or exfoliated cation exchanging layered materials (such as delaminated 2:1 layered silicate clays) can be used as reinforcing filler in a polymer. system. Such polymer systems are known as “nanocomposites” when at least one dimension of the delaminated cation exchanging layered material is less than one hundred nanometers. Typically, transmission electron microscopy of a prior art nanocomposite polymer shows a few or no single layers of delaminated cation exchanging layered material but rather mostly multiple layer stacks of cation exchanging layered material. Never-the-less, prior art nanocomposite polymers generally have enhanced mechanical property characteristics vs. conventionally filled polymers. For example, prior art nanocomposite polymers can provide both increased modulus and increased impact toughness, a combination of mechanical properties that is not usually obtained using conventional fillers.

Cation exchanging layered materials are often treated with an organic cation (usually an “onium”) to facilitate delamination of the cation exchanging layered material when it is blended with a polymer (see, for example U.S. Pat. No. 5,973,053). Conventionally, the layered material is “fully exchanged” or “overexchanged”, i.e., the exchangeable cations of the layered material are essentially fully replaced by onium ions or the exchangeable cations of the layered material are essentially fully replaced by onium ions and the material contains additional onium ions.

The term “cation exchanging layered material” means layered oxides, sulfides and oxyhalides, layered silicates (such as Magadiite and kenyaite) layered 2:1 silicates (such as natural and synthetic smectites, hormites, vermiculites, illites, micas, and chlorites).

The cation exchange capacity of a cation exchanging layered material describes the ability to replace one set of cations (typically inorganic ions such as sodium, calcium or hydrogen) with another set of cations (either inorganic or organic). The cation exchange capacity can be measured by several methods, most of which perform an actual exchange reaction and analyzing the product for the presence of each of the exchanging ions. Thus, the stoichiometry of exchange can be determined on a mole percent basis. It is observed that the various cation exchanging layered materials have different cation exchange capacities which are attributed to their individual structures and unit cell compositions. It is also observed for some cation exchanging layered materials that not all ions of the exchanging type are replaced with the alternate ions during the exchange procedure.

The term “organic cation” means a cation that contains at least one hydrocarbon radical. Examples of organic cations include, without limitation thereto, phosphonium, arsonium, sulfonium, oxonium, imidazolium, benzimidazolium, imidazolinium, protonated amines, protonated amine oxides, protonated betaines, ammoniums, pyridiniums, aniliniums, pyrroliums, piperidiniums, pyrazoliums, quinoliniums, isoqunoliniums, indoliums, oxazoliums, benzoxazoliums, and quinuclidiniums. A typical example of an organic cation is a quaternary ammonium compound of formula R₁R₂R₃R₄N⁺, wherein at least one of R₁, R₂, R₃ or R₄ contains ten or more carbon atoms. The term “organic cation” also includes a protonated amine which can be prepared, for example and without limitation thereto, by the contact of the cation exchanging layered material with an acid followed by contact of the cation exchanging layered material with an organic amine to protonate the amine.

The instant invention provides a composition useful to make a nanocomposite polymer having improved mechanical properties. In one embodiment, the instant invention is a composition of matter useful to make a nanocomposite polymer, comprising: a cation exchanging layered material having a cation exchanging capacity less than or fully exchanged with an organic cation, the cation exchanging layered material being in a liquid comprising an organic solvent, the cation exchanging layered material being delaminated into one, two, three, four, five, six, seven, eight, nine, and/or ten layers and more than ten layers of cation exchanging layered material, the volume percent of the one, two, three, four, five, six, seven, eight, nine and ten layers of cation exchanging layered material being greater than the volume percent of the more than ten layers of cation exchanging layered material upon examination by transmission electron microscopy of a representative freeze dried sample of the composition. Preferably, the cation exchanging layered material is delaminated into one, two, three, four, and/or five layers, and more than five layers of cation exchanging layered material, the volume percent of the one, two, three, four and five layers of cation exchanging layered material being greater than the volume percent of the more than five layers of cation exchanging layered material upon examination by transmission electron microscopy of a representative freeze dried sample of the composition. Preferably, the liquid comprises at least some water even though the liquid preferably consists essentially of an organic solvent (e.g. the liquid is primarily organic solvent with a small amount of water). Preferably, the cation exchanging capacity of the cation exchanging layered material is more than twenty percent exchanged with the organic cation.

A composition of matter of the preceding paragraph which is especially suitable for making nanocomposite epoxy polymers is obtained when the organic solvent consists essentially of acetone and a minor amount of water, wherein the organic cation consists essentially of di-ethoxy methyl alkyl quaternary ammonium wherein the alkyl group has from 12 to 18 carbon atoms, and wherein the cation exchanging layered material is montmorillonite, fluoromica, or sepiolite. It should be understood that the organic cation can be a mixture of organic cations such as a mixture of quaternary ammonium cations including a mixture of the above quaternary ammonium cation and protonated amines that can react with epoxy groups. The presence of free amines on the quaternary ammonium cation is also acceptable as is reaction of the layered material with alkoxy silyl alkyl amines in addition to a quaternary ammonium cation. Preferably, the cation exchanging capacity of the montmorillonite or fluoromica is in the range of from forty to seventy five percent exchanged with the quaternary ammonium organic cation. On the other hand, sepiolite is preferably 100% exchanged with the quaternary ammonium organic cation. A composition of matter of the preceding paragraph which is especially suitable for making nanocomposite polyolefin polymers can be obtained when the organic solvent consists essentially of diethyl benzene and a minor amount of water, wherein the organic cation consists essentially of di-methyl, di-alkyl quaternary ammonium wherein the alkyl group has about 12-20 carbon atoms, and wherein the cation exchanging layered material is montmorillonite or fluoromica and the cation exchanging capacity of the montmorillonite or fluoromica in this case is preferably in the range of from thirty to one hundred percent exchanged with the di-methyl, di-alkyl quaternary ammonium organic cation (and more preferably the cation exchanging capacity of the montmorillonite or fluoromica is in the range of from fifty to eighty percent exchanged with the di-methyl, di-alkyl quaternary ammonium organic cation).

In another embodiment, the instant invention is a composition of matter useful to make a nanocomposite polymer, comprising: a cation exchanging layered material having a cation exchanging capacity less than or fully exchanged with an organic cation, the cation exchanging layered material being in a liquid comprising an organic solvent, less than ten percent of the composition settling upon exposure to 1,500 times gravity for one half hour. Preferably, the liquid comprises at least some water even though the liquid preferably consists essentially of an organic solvent. Preferably, the cation exchanging capacity of the cation exchanging layered material is more than twenty percent exchanged with the organic cation.

A composition of matter of the preceding paragraph which is especially suitable for making nanocomposite epoxy polymers is obtained when the organic solvent consists essentially of acetone and a minor amount of water, wherein the organic cation consists essentially of di-ethoxy methyl alkyl quaternary ammonium wherein the alkyl group has from 12 to 18 carbon atoms, and wherein the cation exchanging layered material is montmorillonite, fluoromica or sepiolite. Preferably, the cation exchanging capacity of the montmorillonite or fluoromica is in the range of from forty to seventy five percent exchanged with the quaternary ammonium organic cation.

A composition of matter of the preceding paragraph which is especially suitable for making nanocomposite polyolefin polymers can be obtained when the organic solvent consists essentially of diethyl benzene and a minor amount of water, wherein the organic cation consists essentially of di-methyl, di-alkyl quaternary ammonium wherein the alkyl group has about 12-20 carbon atoms, and wherein the cation exchanging layered material is montmorillonite or fluoromica and the cation exchanging capacity of the montmorillonite or fluoromica in this case is preferably in the range of from thirty to one hundred percent exchanged with the di-methyl, di-alkyl quaternary ammonium organic cation (and more preferably the cation exchanging capacity of the montmorillonite or fluoromica is in the range of from fifty to eighty percent exchanged with the di-methyl, di-alkyl quaternary ammonium organic cation).

In another embodiment, the instant invention is a composition of matter useful to make a nanocomposite polymer, comprising: a cation exchanging layered material having a cation exchanging capacity less than or fully exchanged with an organic cation, the cation exchanging layered material being in a liquid comprising an organic solvent, the average d-spacing of the layers of cation exchanging layered material being greater than three nanometers upon examination by x-ray diffraction spectroscopy. Preferably, the liquid comprises at least some water even though the liquid preferably consists essentially of an organic solvent. Preferably, the cation exchanging capacity of the cation exchanging layered material is more than twenty percent exchanged with the organic cation.

A composition of matter of the preceding paragraph which is especially suitable for making nanocomposite epoxy polymers is obtained when the organic solvent consists essentially of acetone and a minor amount of water, wherein the organic cation consists essentially of di-ethoxy methyl alkyl quaternary ammonium wherein the alkyl group has from 12 to 18 carbon atoms, and wherein the cation exchanging layered material is montmorillonite or fluoromica. Preferably, the cation exchanging capacity of the montmorillonite or fluoromica is in the range of from forty to seventy five percent exchanged with the quaternary ammonium organic cation.

A composition of matter of the preceding paragraph which is especially suitable for making nanocomposite polyolefin polymers can be obtained when the organic solvent consists essentially of diethyl benzene and a minor amount of water, wherein the organic cation consists essentially of di-methyl, di-alkyl quaternary ammonium wherein the alkyl group has about 12-20 carbon atoms, and wherein the cation exchanging layered material is montmorillonite or fluoromica and the cation exchanging capacity of the montmorillonite or fluoromica in this case is preferably in the range of from thirty to one hundred percent exchanged with the di-methyl, di-alkyl quaternary ammonium organic cation (and more preferably the cation exchanging capacity of the montmorillonite or fluoromica is in the range of from fifty to eighty percent exchanged with the di-methyl, di-alkyl quaternary ammonium organic cation).

In yet another embodiment, the instant invention is a method for preparing a cation exchanging layered material for incorporation in a nanocomposite polymer, comprising the steps of: (a) dispersing a cation exchanging layered material in a liquid comprising water to form a dispersion; (b) adding an organic cation to the dispersion, the amount of organic cation being less than or equal to the cation exchanging capacity of the cation exchanging layered material; and (c) exchanging at least a portion of the water of the liquid for an organic solvent. Step (c) can be accomplished by any suitable unit operation. For example, and without limitation thereto, step (c) can comprise centrifuging the dispersion of step (b) to settle the cation exchanging layered material followed by re-dispersion of the settled cation exchanging layered material in the organic solvent. Or, step (c) can comprise filtering the dispersion of step (b) to form a filter cake of the cation exchanging layered material followed by re-dispersion of the filter cake in the organic solvent. Step (c) should not comprise drying the dispersion.

The method of the preceding paragraph can be used to make a nanocomposite polymer by the further step of mixing the cation exchanging layered material of step (c) with a polymer to produce a nanocomposite polymer. Preferably the cation exchanging layered material is delaminated in the polymer matrix into one, two, three, four, five, six, seven, eight, nine, and/or ten layers and more than ten layers of cation exchanging layered material, the volume percent of the one, two, three, four, five, six, seven, eight, nine and ten layers of cation exchanging layered material being greater than the volume percent of the more than ten layers of cation exchanging layered material upon examination by transmission electron microscopy of a representative sample of the nanocomposite polymer. Preferably, the cation exchanging layered material is delaminated in the polymer matrix into one, two, three, four, and/or five layers, and more than five layers of cation exchanging layered material, the volume percent of the one, two, three, four and five layers of cation exchanging layered material being greater than the volume percent of the more than five layers of cation exchanging layered material upon examination by transmission electron microscopy of a representative sample of the nanocomposite polymer. Any type of polymer can be used. When the polymer is a thermoplastic polymer, the mixing can be done using an extruder. When the polymer is a thermoset polymer, the composition can be mixed with a thermoset polymer component (such as the resin or hardener of an epoxy polymer) or with uncured thermoset polymer. The solvent or liquid is removed after at least some mixing of the cation exchanging layered material with the polymer or thermoset polymer component. When mixing is done in an extruder the solvent or a portion of it may be removed in the last stage or stage of the extruder or the solvent or a portion of it may be removed subsequent to the extrusion step. When the polymer is a thermoset, the solvent can be removed after mixing the cation exchanging layered material with the thermoset precursor (e.g. monomer, or oligomer, or monomer or oligomer plus hardener) but is preferably removed before the curing step, although some solvent may be removed during curing by heating.

A nanocomposite polymer can be made using the compositions of the instant invention by polymerizing one or more monomers (such as monomers polymerized by free radical polymerization) in the presence of the cation exchanging layered material of step (c) of the method of the instant invention to produce a nanocomposite polymer. Preferably, the cation exchanging layered material is delaminated in the polymer matrix into one, two, three, four, five, six, seven, eight, nine, and/or ten layers and more than ten layers of cation exchanging layered material, the volume percent of the one, two, three, four, five, six, seven, eight, nine and ten layers of cation exchanging layered material being greater than the volume percent of the more than ten layers of cation exchanging layered material upon examination by transmission electron microscopy of a representative sample of the nanocomposite polymer. Preferably, the cation exchanging layered material is delaminated in the polymer matrix into one, two, three, four, and/or five layers, and more than five layers of cation exchanging layered material, the volume percent of the one, two, three, four and five layers of cation exchanging layered material being greater than the volume percent of the more than five layers of cation exchanging layered material upon examination by transmission electron microscopy of a representative sample of the nanocomposite polymer.

A nanocomposite polymer can be made using the compositions of the instant invention by mixing the cation exchanging layered material of step (c) of the method of the instant invention with a solution of a thermoplastic polymer (such as the solution of ethylene/octene polymer from a solution process for making “polyethylene”) followed by the step of removing solvent from the thermoplastic polymer to produce a nanocomposite polymer. Preferably, the cation exchanging layered material is delaminated in the polymer matrix into one, two, three, four, five, six, seven, eight, nine, and/or ten layers and more than ten layers of cation exchanging layered material, the volume percent of the one, two, three, four, five, six, seven, eight, nine and ten layers of cation exchanging layered material being greater than the volume percent of the more than ten layers of cation exchanging layered material upon examination by transmission electron microscopy of a representative sample of the nanocomposite polymer. Preferably, the cation exchanging layered material is delaminated in the polymer matrix into one, two, three, four, and/or five layers, and more than five layers of cation exchanging layered material, the volume percent of the one, two, three, four and five layers of cation exchanging layered material being greater than the volume percent of the more than five layers of cation exchanging layered material upon examination by transmission electron microscopy of a representative sample of the nanocomposite polymer.

The specific organic solvent used in the instant invention (or mixture of two or more organic solvents) will depend on the specific application. The following theory can be used as a guide to help determine a suitable solvent or mixture of solvents. For example and without limitation thereto, a composition of the instant invention having more organic solvent can be mixed with a polyol followed by devolitilization of the organic solvent from the polyol followed by mixing of the polyol with an isocyanate.

The theory of the instant invention (to which applicants should not be held) is presented in this paragraph. The cation exchanging layered material must first be dispersed in water and then exposed to the organic cation so that the cation exchanging layered material is relatively evenly exchanged with the organic cation and to facilitate, for example and without limitation thereto, centrifugation or filtration of the organic cation treated cation exchanging layered material (the organic cation treated cation exchanging layered material tends to coagulate in water thereby facilitating its separation from the majority of the water). Then, exchanging the water for an organic solvent re-disperses the organic cation treated cation exchanging layered material in the organic solvent. This step can be repeated to further reduce the water content of the dispersion. However, it is believed that a small amount of residual water may be beneficial in the instant invention. If the content of the organic cation treated cation exchanging layered material in the organic solvent is relatively low, then a colloidal suspension can be obtained which, for example and without limitation thereto, can be mixed with uncured epoxy resin to make a nanocomposite epoxy polymer as described in greater detail in a following example. If the content of the organic cation treated cation exchanging layered material in the organic solvent is relatively high, then a paste is obtained which, for example and without limitation thereto, can be mixed with a thermoplastic resin in an extruder to make a nanocomposite thermoplastic polymer as described in greater detail in a following example. In any event, it is believed that the layer to layer separation of the layers of the organic cation treated cation exchanging layered material in the organic solvent is increased relative to an organic cation treated cation exchanging layered material which has been dried and then exposed to an organic solvent. It is believed that when the organic cation treated cation exchanging layered material is dried and then exposed to an organic solvent that the layer to layer separation is less (and delamination is less in a nanocomposite polymer made therewith) than if the organic cation treated cation exchanging layer material is not dried before it is exposed to the organic solvent. It is known that cation treated cation exchanging layered material having an increased layer to layer thickness or separation delaminates to a greater degree in a nanocomposite polymer and produces a nanocomposite polymer having improved mechanical properties. It is also believed that the cation exchanging layered material should have a cation exchanging capacity less than or fully exchanged with an organic cation, preferably less than fully exchanged for many types of cation exchanging layered material such as fluoromica and magadiite. It is believed that the combination of not drying the organic cation treated cation exchanging layered material in the instant invention together with the exposure to the organic solvent results in increased layer to layer separation which has an optimum at an exchange percent which depends on the specific type of cation exchanging layered material. In addition, it is believed that it is best when the organic solvent has a similar polarity as the organic groups of the organic cation. For example, when the solvent is acetone, then an organic cation having ethoxy groups is better than an organic cation having long chain hydrocarbon groups. And, when the solvent is diethyl benzene, then organic cation having long chain hydrocarbon groups is better than an organic cation having ethoxy groups. It is believed that when the organic solvent has a similar polarity as the organic groups of the organic cation exchanged on the cation exchanging layered material and when the area of the organic cation exchanged on the cation exchanging layered material leaves room for the addition of the organic solvent, the organic solvent will intercalate between the layers of the cation exchanging layer material to associate with the organic cation thereby increasing the layer to layer separation. It should be understood that the above discussion in this paragraph is only theory and that applicants do not intend to be held thereto.

### EXAMPLE 1

### Preparation of Colloidal Solution of Organoclay in Acetone

50 g of Cloisite NA brand clay (Southern Clay Products) is mixed into 5 liters of water and left to stir overnight. The next day 137.8 g of 10%-solution of Ethoquad C/12 (Akzo Nobel, di-ethoxy, methyl, C12-14 quaternary ammonium chloride) in ethanol is added to the clay suspension. The mixture is allowed to stir for another seven hours, after which the organoclay is separated from liquid by vacuum filtration and washed with water until the conductivity of washing water dropped down to 20 uS/cm at room temperature. 30 g of the filter cake is re-dispersed in 15 ml of acetone. The re-dispersed filter cake is placed in a centrifuge for five minutes at 2,000 times gravity to settle the filter cake. The liquid on top is discarded and another 200 ml of acetone is added to re-disperse the filter cake. The re-dispersed filter cake is placed in a centrifuge at 2,000 times gravity for 30 minutes with essentially no settling of the treated clay.

### EXAMPLE 2

### Preparation of Epoxy Nanocomposite

To 200 ml of suspension of Example 1, 40 g of DER 383 (Dow Chemical) epoxy resin is added. The mixture is then placed on rotary evaporator until most of the acetone is removed. The resulting thick mixture is then placed in a vacuum oven at sixty degrees Centigrade overnight to complete solvent removal. The next day 12.0 g of Jeffamine D230 (Hunsman) curing agent is added. The mixture is thoroughly stirred by hand and poured into a test mold and cured at sixty degrees Centigrade overnight followed by a treatment at one hundred and twenty degrees Centigrade for 1.5 hour. The resulting light-yellow bars are optically clear and contained well exfoliated 2.5% by weight of the treated clay as determined by transmission electron microscopy.

### EXAMPLE 3

### Preparation of Colloidal Solution of Reactive Organoclay in Acetone

A 1.85% w/w suspension of Cloisite NA in water is prepared by stirring the clay into eighty degree Centigrade water overnight. Separately, a solution of Ethoquad C/12 and quaternary salt of dodecylamine with 45:25 mole ratio is prepared in an ethanol/water mixture adjusted to 3% w/w of Ethoquad C/12. These solutions are combined to produce 1: 0.46 mole clay-to-quat exchange ratio with regard to Ethoquad. The final composition of the resulting organoclay is calculated to be 46% of Ethoquad C/12 and 25.5% of quaternary dodecylamine. The treated organoclay is separated from the liquid by vacuum filtration and washed with water until the conductivity of washing water dropped down to 20 uS/cm at room temperature. 30 g of the filter cake is re-dispersed in 15 ml of acetone. The re-dispersed filter cake is placed in a centrifuge for five minutes at 2,000 times gravity to settle the filter cake. The liquid on top is discarded and another 200 ml of acetone is added to re-disperse the filter cake. The re-dispersed filter cake is placed in a centrifuge at 2,000 times gravity for 30 minutes with essentially no settling of the treated clay.

### EXAMPLE 4

### Preparation of Epoxy Nanocomposite

To 200 ml of the colloidal suspension of Example 3, 50 g of DER 383 epoxy resin (Dow Chemical) and 17 g of 4-aminophenyl sulfone hardener (Aldrich) are added. The solution is shaken until all solids were completely dissolved and placed on a rotary evaporator to remove most of the acetone. The resulting mixture is then placed into a seventy degree Centigrade vacuum oven overnight to complete acetone removal. The next day this mixture is cured at one hundred and twenty degrees Centigrade for 4 hours followed by a final cure at one hundred and sixty degrees for an additional 5 hours. The resulting light-yellow plaque is optically clear and contains 2.3% clay as determined by TGA. The degree of exfoliation is even better than observed in Example 2. In this case, the epoxy matrix is chemically bonded to the surface of organoclay via reaction with dodecylamonium ions.

### EXAMPLE 5

### Preparation of Organo Clay Paste

A water solution of 2% montmorillonite clay (Cloisite NA) is prepared by vigorously mixing dry clay powder into hot water. The mixture is allowed to cool and is left undisturbed for 2 days allowing the large particles to settle down to the bottom of the vessel. The top portion of the mixture is separated for further use. Separately, a 3% solution of Arquat 2HT (di-mehtyl, di-C16-18 quaternary ammonium chloride) in ethanol is prepared. Both solutions are preheated to 70° C. and combined with appropriate flow rates resulting in a preparation of Arquat 2HT organoclay with clay-to quat ratio of 1:0.5 based on the formula weight of montmorillonite clay.

The organoclay is separated from the liquor by vacuum filtration and washed with fresh water until most of the NaCl salt is removed, as monitored by conductivity measurement on separated liquor. 150 g of water wet filter cake is put into a centrifuge container and 300 ml of acetone is added. The mixture is vigorously shaken until the clay is dispersed uniformly in the solvent. The clay is then separated from the solvent by centrifugation and the liquor is discarded. The same washing procedure is repeated with another 300 ml of acetone followed by two 250 ml washes with diethylbenzene. The final product is a thick gel of organoclay in diethylbenzene.

### EXAMPLE 6

### Preparation of Polypropylene Nanocomposite

Polypropylene resin (Inspire 112) and maleated polypropylene compatibilizer (Polybond 3150) are ground to fine powder. 25 g of compatibilizer is added to the gel of Example 5. The two are thoroughly mixed until a homogeneous paste is obtained and added to 300 g of the polypropylene resin powder and further mixed. This mixture is fed into a twin-screw extruder equipped with a devolitazion port at the end of the mixing barrel to remove the solvent. The resulting polypropylene nanocomposite exhibits much better distribution and exfoliation of clay platelets (based on TEM imaging) compared to a polypropylene nanocomposite prepared using the same organoclay which had been dried. The presence of large clay agglomerates (1 μm and larger) in the polymer matrix was essentially completely eliminated. The resulting mechanical properties of the nanocomposite (flex modulus and impact toughness) are also significantly better than the mechanical properties of the nanocomposite made using same organoclay which had been dried.

### CONCLUSION

In conclusion, it should be readily apparent that although the invention has been described above in relation with its preferred embodiments, it should be understood that the instant invention is not limited thereby but is intended to cover all alternatives, modifications and equivalents that are included within the scope of the invention as defined by the following claims.

1. A composition of matter comprising: a cation exchanging layered material comprising a silicate clay or 2:1 layered silicate clay and having a cation exchanging capacity less than or fully exchanged with an organic cation, the cation exchanging layered material being in a liquid comprising an organic solvent, further characterized by one or more of the following
(a) the cation exchanging layered material being delaminated into one, two, three, four, five, six, seven, eight, nine, and/or ten layers and more than ten layers of cation exchanging layered material, the volume percent of the one, two, three, four, five, six, seven, eight, nine and ten layers of cation exchanging layered material being greater than the volume percent of the more than ten layers of cation exchanging layered material upon examination by transmission electron microscopy of a representative freeze dried sample of the composition,
(b) less than ten percent of the cation exchanging layered material settling upon exposure to 1,500 times gravity for one half hour; and
(c) the average d-spacing of the layers of cation exchanging layered material being greater than three nanometers upon examination by x-ray diffraction spectroscopy.

2. The composition of matter of claim 1, wherein the cation exchanging layered material being delaminated into one, two, three, four, and/or five layers, and more than five layers of cation exchanging layered material, the volume percent of the one, two, three, four and five layers of cation exchanging layered material being greater than the volume percent of the more than five layers of cation exchanging layered material upon examination by transmission electron microscopy of a representative freeze dried sample of the composition.

3. The composition of matter of claim 1, wherein the liquid comprises the organic solvent and water.

4. The composition of matter of claim 1, wherein the liquid consists essentially of an organic solvent.

5. The composition of matter of claim 1, wherein the cation exchanging capacity of the cation exchanging layered material is more than twenty percent exchanged with the organic cation.

6. The composition of matter of claim 1, wherein the organic solvent consists essentially of acetone and a minor amount of water, wherein the organic cation consists essentially of di-ethoxy methyl alkyl quaternary ammonium wherein the alkyl group has from 12 to 18 carbon atoms, and wherein the cation exchanging layered material is montmorillonite, fluoromica, or sepiolite.

7. The composition of matter of claim 6, wherein the cation exchanging capacity of the montmorillonite or fluoromica is in the range of from forty to eighty five percent exchanged with the quaternary ammonium organic cation.

8. The composition of claim 6, wherein the organic cation comprises a mixture of two or more organic cations.

9. The composition of claim 8, wherein the organic cation comprises a quaternary ammonium compound and a protonated amine or free amine that is reactive with epoxy groups.

10. The composition of matter of claim 1, wherein the organic solvent consists essentially of diethyl benzene and a minor amount of water, wherein the organic cation consists essentially of di-methyl, di-alkyl quaternary ammonium wherein the alkyl group has about 12-20 carbon atoms, and wherein the cation exchanging layered material is montmorillonite, fluoromica or sepiolite.

11. The composition of matter of claim 10, wherein the cation exchanging capacity of the montmorillonite, fluoromica, or sepiolite is in the range of from thirty to one hundred percent exchanged with the di-methyl, di-alkyl quaternary ammonium organic cation.

12. The composition of matter of claim 10, wherein the cation exchanging capacity of the montmorillonite or fluoromica is in the range of from fifty to eighty percent exchanged with the di-methyl, di-alkyl quaternary ammonium organic cation.

13. The composition of matter of claim 10, wherein the organic cation comprises one or more organic cations.

14. A method comprising the steps of: (a) dispersing a cation exchanging layered material in a liquid comprising water to form a dispersion; (b) adding an organic cation to the dispersion, the amount of organic cation being less than or equal to the cation exchanging capacity of the cation exchanging layered material; and (c) exchanging at least a portion of the water of the liquid for an organic solvent to give a composition of matter of claim 1.

15. The method of claim 14, wherein step (c) comprises centrifuging the dispersion of step (b) to settle the cation exchanging layered material followed by re-dispersion of the settled cation exchanging layered material in the organic solvent.

16. The method of claim 14, wherein step (c) comprises filtering the dispersion of step (b) to form a filter cake of the cation exchanging layered material followed by re-dispersion of the filter cake in the organic solvent.

17. The method of claim 14, further comprising the step of: mixing the cation exchanging layered material of step (c) with a polymer, polymer component or prepolymer to produce a nanocomposite polymer wherein the cation exchanging layered material is delaminated in the polymer matrix into one, two, three, four, five, six, seven, eight, nine, and/or ten layers and more than ten layers of cation exchanging layered material, the volume percent of the one, two, three, four, five, six, seven, eight, nine and ten layers of cation exchanging layered material being greater than the volume percent of the more than ten layers of cation exchanging layered material upon examination by transmission electron microscopy of a representative sample of the nanocomposite polymer.

18. The method of claim 17, wherein the cation exchanging layered material is delaminated in the polymer matrix into one, two, three, four, and/or five layers, and more than five layers of cation exchanging layered material, the volume percent of the one, two, three, four and five layers of cation exchanging layered material being greater than the volume percent of the more than five layers of cation exchanging layered material upon examination by transmission electron microscopy of a representative sample of the nanocomposite polymer.

19. The method of claim 17, wherein the polymer is a thermoplastic polymer and the polymer is mixed with the composition in an extruder and the solvent is removed after at least some mixing of the polymer and the cation exchanging layered material has occurred.

20. The method of claim 17, wherein the polymer is a thermoset polymer and the composition is mixed with a thermoset polymer component or with uncured thermoset polymer and the solvent is removed after at least some mixing of the polymer and the cation exchanging layered material has occurred.

21. The method of claim 17, wherein the polymer is a urethane polymer and the composition is mixed with a polyol to form a polyol mixture with the composition which polyol mixture is then devolatilized to remove most of the organic solvent and then reacted with an isocyanate to produce the urethane polymer.

22. The method of claim 14, further comprising the step of: polymerizing one or more monomers in the presence of the cation exchanging layered material of step (c) to produce a nanocomposite polymer wherein the cation exchanging layered material is delaminated in the polymer matrix into one, two, three, four, five, six, seven, eight, nine, and/or ten layers and more than ten layers of cation exchanging layered material, the volume percent of the one, two, three, four, five, six, seven, eight, nine and ten layers of cation exchanging layered material being greater than the volume percent of the more than ten layers of cation exchanging layered material upon examination by transmission electron microscopy of a representative sample of the nanocomposite polymer.

23. The method of claim 14, further comprising the step of mixing the mixing cation exchanging layered material of step (c) with a solution of a thermoplastic polymer followed by the step of removing solvent from the thermoplastic polymer to produce a nanocomposite polymer wherein the cation exchanging layered material is delaminated in the polymer matrix into one, two, three, four, five, six, seven, eight, nine, and/or ten layers and more than ten layers of cation exchanging layered material, the volume percent of the one, two, three, four, five, six, seven, eight, nine and ten layers of cation exchanging layered material being greater than the volume percent of the more than ten layers of cation exchanging layered material upon examination by transmission electron microscopy of a representative sample of the nanocomposite polymer.

24. The method of claim 22, wherein the cation exchanging layered material is delaminated in the polymer matrix into one, two, three, four, and/or five layers, and more than five layers of cation exchanging layered material, the volume percent of the one, two, three, four and five layers of cation exchanging layered material being greater than the volume percent of the more than five layers of cation exchanging layered material upon examination by transmission electron microscopy of a representative sample of the nanocomposite polymer.

25. The method of claim 20 wherein at least a portion of the solvent is removed prior to cure.

26-27. (canceled)
